(19) United States
(12) Patent Application Publication
(10) Pub. No.: US 2014/0324578 A1
(43) Pub. Date: Oct. 30, 2014

(54) SYSTEMS AND METHODS FOR INSTANT E-COUPON DISTRIBUTION

(71) Applicant: YAHOO! INC., Sunnyvale, CA (US)

(72) Inventors: Ghost Chen, Taipei (TW); Kaden Chiang, Taipei (TW); Charles Chuang, Taipei (TW); Roga Lin, Taipei (TW); Marco Chen, Taipei (TW)

(73) Assignee: Yahoo! Inc., Sunnyvale, C (unknown)

(21) Appl. No.: 13/872,754

(22) Filed: Apr. 29, 2013

(51) Int. Cl. G06Q 30/02

(52) U.S. Cl. CPC G06Q 30/0255
USPC 705/14.53

(57) ABSTRACT

A system for online e-coupon distribution comprises a processor in communication with the computer-readable storage medium. The processor may execute a set of instructions saved in the computer-readable medium to receive purchase intention (PI) information associated with a user and a target product, and then determine, based on the PI information, a PI score that reflects a present purchase intention of the user. If the PI score exceeds a predetermined value, the processor may provide an online e-coupon associated with the target product to a target webpage rendered to the user.

### BACKGROUND

In general internet commerce, online sales promotions are often used to provide a short-term purchasing incentive to consumers. Typical sales promotions include rebates, samples, contests, loyalty awards, and coupons. Coupons are certificates that entitle a bearer to stated savings on the purchase of a specific product or product bundle. Both manufacturers and merchants issue electronic coupons, or e-coupons, through Internet and distributed e-coupons to users directly on a webpage that a web user is browsing.

To identify a potential buyer, an online shop owner and/or platform provider generally collect historical internet activity data of web users and predict a current purchase intention of the web users by conducting data mining under a batch distribution model. Upon finding that a web user currently possesses an intention to perform a purchase, the manufacturers or merchants will provide a long-term or mid-term coupon of the product to the web user.

However, in practice, an online shop owner or platform provider may find it difficult to provide a commercially viable e-coupon distribution service for the manufacturers and merchants based on the batch distribution model. For example, implementation of a batch distribution model is complicated. A basic implementation of batch distribution model may need many components such as a data warehouse, a complex data mining algorithm, a pattern matching service, e-coupons databases, performance reporting and monitoring systems. It may be difficult for an online shop owner or platform provider to provide such a system.

In addition, an online shop owner and/or platform provider may often find the relevancy between the historical data mining and current purchase intention of a web user too low to convey an accurate prediction. To identify buyers, modern implementation of the batch distribution model require the online shop owner and/or platform provider to conduct historical data mining in batch to predict purchase intention of web users. Because finding relevancy between patterns among data is a general and difficult problem in data mining computation, the online shop owner and/or platform provider usually finds it difficult to extract useful information when conducting data pattern matching, especially for conducting timely pattern matching. Further, a web user often loses interest in a particular product or has already purchased the product by the time the purchase intention of the web user is reflected in the historical data of a web user. For these reasons, the above data mining strategy may result in a low distribution efficiency and/or e-coupons are not delivered to the web user in a timely manner.

### BRIEF DESCRIPTION OF THE DRAWINGS

The described systems and methods may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 is a schematic diagram illustrating an example network environment;

FIG. 2 is a schematic diagram illustrating an example client device;

FIG. 3 is a schematic diagram illustrating an example server;

FIG. 4 is a schematic diagram illustrating one implementation of an online e-coupon distribution system; and

FIG. 5 is a flow chart illustrating one implementation of a method of distributing an e-coupon to a web user.

### DETAILED DESCRIPTION OF THE DRAWINGS

The present disclosure is directed to computer-implemented systems and methods for calculating a purchase intention score for online e-coupon distribution. The purchase intention score may reflect a degree to which a web user intends to purchase a target product. In some implementations, the purchase intention score incorporates both historical purchase intention information and instant purchase intention information of a web user.

### I. Illustrative Network Environment

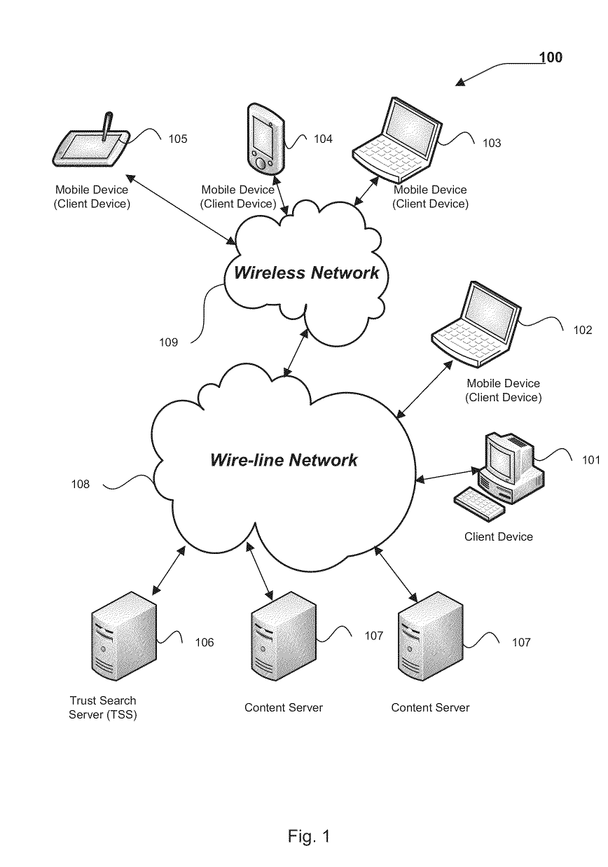

FIG. 1 is a schematic diagram of an example network environment that the methods for calculating a purchase intention score for online e-coupon distribution may operate in. Other network environments that may vary, for example, in terms of arrangement or in terms of type of components, are also intended to be included within claimed subject matter. As shown, FIG. 1, for example, a network 100 may include a variety of networks, such as Internet, one or more local area networks (LANs) and/or wide area networks (WANs), wire-line type connections 108, wireless type connections 109, or any combination thereof. The network 100 may couple devices so that communications may be exchanged, such as between servers (e.g., content server 107 and search server 106) and client devices (e.g., client device 101-105 and mobile device 102-105) or other types of devices, including between wireless devices coupled via a wireless network, for example. A network 100 may also include mass storage, such as network attached storage (NAS), a storage area network (SAN), or other forms of computer or machine readable media, for example.

A network may also include any form of implementations that connect individuals via communications network or via a variety of sub-networks to transmit/share information. For example, the network may include content distribution systems, such as peer-to-peer network, or social network. A peer-to-peer network may employ computing power or bandwidth of network participants for coupling nodes via an ad hoc arrangement or configuration, wherein the nodes serves as both a client device and a server. A social network may be a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like. A social network also may generate relationships or connections with entities other than a person, such as companies, brands, or so-called ‘virtual persons.’ An individual's social network may be represented in a variety of forms, such as visually, electronically or functionally. For example, a “social graph” or “socio-gram” may represent an entity in a social network as a node and a relationship as an edge or a link. Overall, any type of network, traditional or modern, that may facilitate information transmitting or advertising is intended to be included in the concept of network in the present application.

### II. Illustrative Components of Network Environment

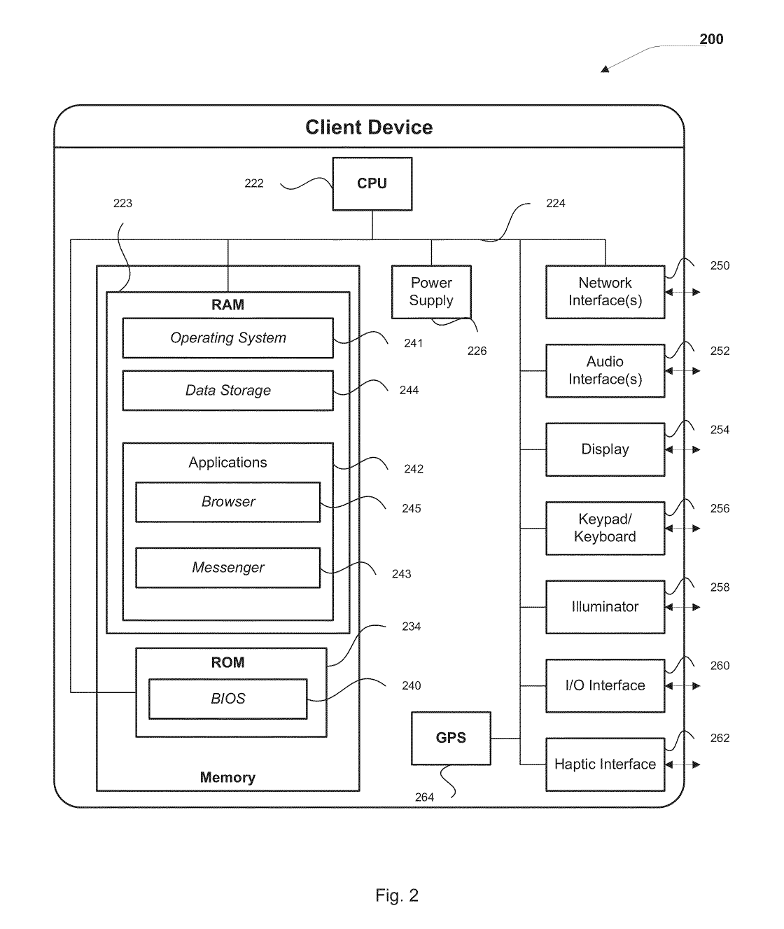

FIG. 2 is a schematic diagram illustrating an example client device that may be used in a network, such as the network illustrated in FIG. 1. A client device may include a computing device capable of sending or receiving signals, such as via a wired or a wireless network. A client device may, for example, include a desktop computer 101 or a portable device 102-105, such as a cellular telephone or a smart phone 104, a display pager, a radio frequency (RF) device, an infrared (IR) device, a Personal Digital Assistant (PDA), a handheld computer, a tablet computer 105, a laptop computer 102-103, a set top box, a wearable computer, an integrated device combining various features, such as features of the forgoing devices, or the like.

A client device may vary in terms of capabilities or features. Claimed subject matter is intended to cover a wide range of potential variations. For example, a client device may include a keypad/keyboard 256 or a display 254, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) 264 or other location-identifying type capability, or a display with a high degree of functionality, such as a touch-sensitive color 2D or 3D display, for example.

A client device may include or may execute a variety of operating systems 241, including a personal computer operating system, such as a Windows, iOS or Linux, or a mobile operating system, such as iOS, Android, or Windows Mobile, or any operating system available at time of filing of this application or in the future. A client device may include or may execute a variety of possible applications 242, such as a browser 245 and/or a messenger 243. A client application 242 may enable communication with other devices, such as communicating one or more messages, such as via email, short message service (SMS), or multimedia message service MMS), including via a network, such as a social network, including, for example, Facebook™, LinkedIn™, Twitter™, Flickr™, or Google™, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games such as fantasy sports leagues). The foregoing is provided to illustrate that claimed subject matter is intended to include a wide range of possible features or capabilities.

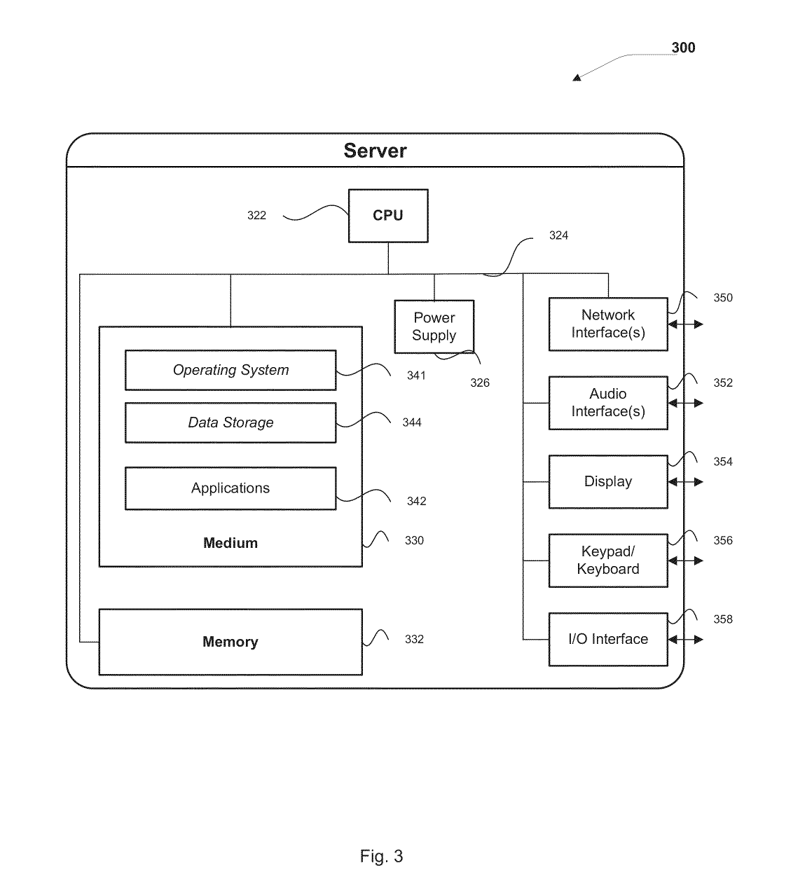

FIG. 3 is a schematic diagram illustrating an example server that may be used in a network, such as the network illustrated in FIG. 1. A Server 300 may vary widely in configuration or capabilities, but it may include one or more central processing units 322 and memory 332, one or more medium 630 (such as one or more mass storage devices) storing application programs 342 or data 344, one or more power supplies 326, one or more wired or wireless network interfaces 350, one or more input/output interfaces 358, and/or one or more operating systems 341, such as Windows Server™, Mac OS X™, Unix™, Linux™, FreeBSD™, or the like. Thus a server 300 may include, as examples, dedicated rack-mounted servers, desktop computers, laptop computers, set top boxes, integrated devices combining various features, such as two or more features of the foregoing devices, or the like.

The server 300 may serve as a search server 106 or a content server 107. A content server 107 may include a device that includes a configuration to provide content via a network to another device. A content server may, for example, host a site, such as a social networking site, examples of which may include, but are not limited to, Flicker™, Twitter™, Facebook™, LinkedIn™, or a personal user site (such as a blog, vlog, online dating site, etc.). A content server 107 may also host a variety of other sites, including, but not limited to business sites, educational sites, dictionary sites, encyclopedia sites, wikis, financial sites, government sites, etc. A content server 107 may further provide a variety of services that include, but are not limited to, web services, third party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor type or programmable consumer electronics, etc.

When the server 300 delivers webpages to a client device (e.g. the client device 200 in FIG. 2) via a network, the server 300 may be able to recognize the client device by any technologies available at the time of filing of this application or in the future. For example, the server 300 may recognize the client device via a name of the client device, system hostname of the client device, internet protocol (IP) address of the client device, WiFi address of the client device, media access control MAC) address of the client device, International Mobile Station Equipment Identity (IMEI) of the client device, Integrated Circuit Card Identifier (ICCID) contained in a SIM card of the client device, or cookies stored in the client device. Accordingly, the server 300 may be able to conduct online sales promotion activities to an owner (a web user) of the client device when the web user is visiting a webpage delivered by the server 300.

### III. Illustrative Examples

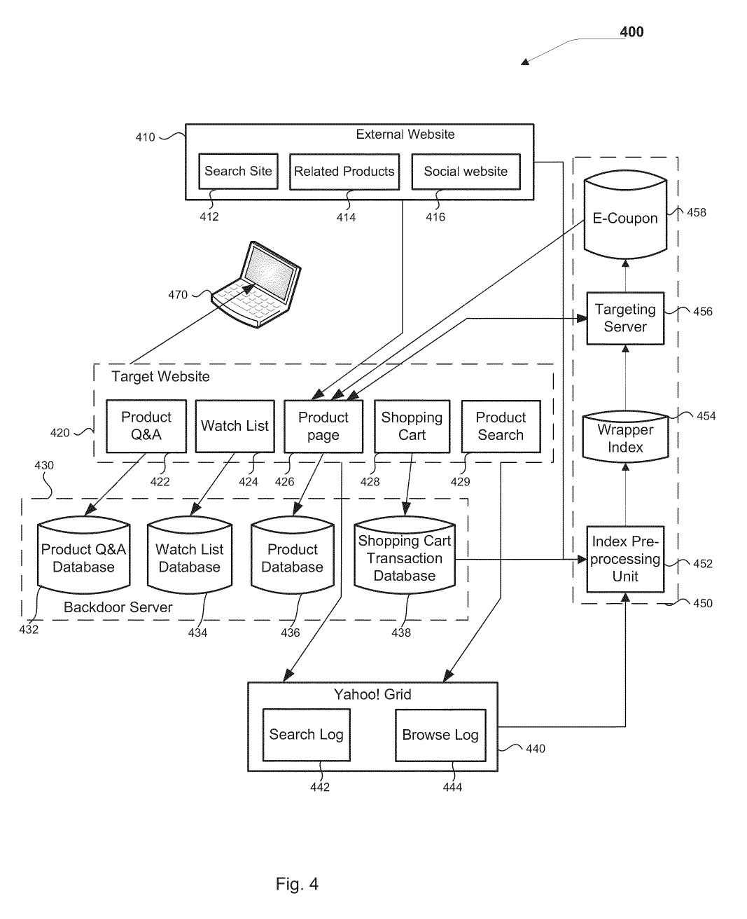

FIG. 4 is a schematic diagram illustrating an online e-coupon distribution system that may be implemented in a network, such as the network 100 illustrated in FIG. 1. The online e-coupon distribution system 450 may include an index-preprocessing unit 452 for collecting and/or receiving information that reflects historical and instant purchase intention (PI) of a web user (not shown) concerning a target product. For example, if a web user purchased a target product before, his prior purchasing history may reflect that the user may have a historical purchase intention to the target product. Similarly, if the web user browsed webpages of the target product over ten times within a day, the browsing history may reflect that the web user may have an instant purchase intention to the target product.

A wrapper index 454 may be used to save data of the PI information of the web user. The wrapper index 454 may be a data mining result from historical online activity data of a web user. A targeting server 456 (e.g., a purchase intent engine) may analyze the data related to PI information and, upon a determination that the web user has a purchase intention higher than a threshold value, provide the web user an e-coupon 458 for purchasing the target product.

In some implementations, the index preprocessing unit 452 may be integrated with a target website 420, such as an online shopping website. When a web user is browsing the target website 420, a backdoor server 430 may deliver webpages of the target website 420 to the web user. The backdoor server 430 may be the server 300 in FIG. 3. In some implementations, the client device 470 may be the client device 200 in FIG. 2.

The target website 420 may sell various products and may provide various webpages, functions, tool bars, and/or links to the client device 470. For example, for each product, the target website 420 may provide a product page 426, a corresponding product Q&A (question & answer) page 422, and/or a webpage/tool bar/function 429 for searching for products within and/or outside the target website 420. If the web user is registered with the target website 420 and the web user logs into their account while browsing the target website 420, the target website 420 may also provide a shopping cart 428 and a watch list 424 for the web user. For example, the shopping cart 328 may be a webpage showing the prior purchasing history of the web user and the watch list 424 may be a webpage showing a list of products that the web user shows special interest in.

Operation of the target website 420 webpages, functions, tool bars, and/or links may be supported by various databases saved in the backdoor server 430. For example, information of each product and product Q&A may be saved in a product database 436 and a product Q&A database 432, respectively. When a web user browses the product page 424 or the product Q&A page 422, the backdoor server 430 may retrieve from the produce database 436 and/or the product Q&A database 432 the corresponding information and deliver the information to the corresponding webpages shown on the client device 470. Information of the watch list 424 and the shopping cart 428 that is associated with the account of the web user may also be saved in a watch list database 434 and a shopping cart transaction database 438, respectively. Thus, when the web user logs in the online shopping webpage 420 and checks their watch list or historical transaction history in the target website 420, the backdoor server 430 may retrieve the corresponding information and may deliver the information to the corresponding webpage.

Being integrated with the target website 420, the index preprocessing unit 452 may receive and/or collect product data from the databases of the target website 420, such as a “product name,” “product category tree,” and “transaction log.”

A product in this application may be a specific object or service that the target website 420 sells. A category in this application may refer to a collection of things sharing a common attribute. For example, an iPhone 4™ is a specific object that may be physically on sale in the target website 420. Therefore, the iPhone 4™ may be a product under the definition of this application. Similarly, a Samsung Galaxy S4™ may also be a product under the definition of this application. “Smart phone” may be a concept that refers any mobile phone that offers more advanced computing ability and connectivity than a contemporary basic feature phone. Thus “smart phone” may be a category under the definition of this application. Since both an iPhone 4™ and a Samsung Galaxy S4™ are capable of conducting more advanced computing ability and connectivity than a contemporary basic feature phone, they are both under the same category as smart phones.

A product category tree may be a tree-shaped data structure that organizes all categories and sub-categories of product that the target website 420 sells. For example, the main category of the product category tree may comprise entries such as “articles of daily use” and “30,” The “30” category may comprise sub-categories such as “smart phone,” “camera,” “TV,” etc. The sub-category “smart phone” may further comprises sub-categories such as “iPhone,” “Nokia,” “Sony,” “Samsung,” etc.

A transaction log may be a transaction record of a buyer (e.g., the web user). It may include all necessary details of transactions that the buyer conducted in a defined period of time. For example, a transaction log of a registered web user may record all historical transactions of all products that the web user purchased on the target website 420. Each historical transaction record may include the time, price, product, credit card information, and shipping address of the transaction.

The index preprocessing unit 452 may also receive and/or collect historical online activities of the web user on the target website 420. The historical online activities may be information reflecting historical purchase intention of the web user in a defined period of time (e.g. 2 weeks or 14 weeks). For example, the index preprocessing unit 452 may receive and/or collect from the shopping cart of the web user an online purchasing history of the web user for a period of a previous two weeks. The index preprocessing unit 452 may also receive and/or collect product names saved in the watch list 424 of the account for the period of a previous two weeks. The product names may reflect products that the web user is interest in. Such information is available when the web user is a registered member of the target website 420 and has an account therein, and are thus account specific.

Other historical online activity information, such as time, length, and frequency that the web user visits the product page 426, questions/answers/comments that the web user left on the product Q&A page 422, and terms that the web user searched in the product search page 429, is not associated with the account of the web user, and thus are general historical online activities. The backdoor server 420 and the index preprocessing unit 452 may be able to save and associate the general online activities of the user by recognizing the client device 470 that the user uses when surfing a network.

In the event that the target website is based on a “Grid” 440, such as the YUI Grids CSS from Yahoo!™, the above purchase intention information for the web user may also be saved in various logs in the Grid 440. For example, the searching history of the web user may be saved in a search log 442 of the Grid 440 and the browsing history of the web user may be saved in a browse log 444 of the web user. Digital humanity (DH), a technology that excels in curating online collections to data mining large cultural data sets, may be applied to the Grid 440 to provide effective data mining for historical online activities of the web user. Thus, the index preprocessing unit 452 may be able to receive and/or collect the above account specific and general historical purchase intention information through the Grid 440.

In addition to the historical online activities, the index preprocessing unit 452 may also collect and/or receive recent online activities of the web user on the target website 420 in a defined period of time (e.g., within 1 hour, 1 day, or 7 days). The recent online activities may be conducted in a more recent period of time compared to the historical online activities so that it may be information reflecting or strongly related to instant purchase intention of the web user at the time of browsing the target webpage 420. For example, online activities conducted 1 hour ago may strongly reflect the instant purchase intention of the web user. The instant purchase intention information may include, within the defined period of time, search terms of the web user on the product search page 429 and/or from a referral webpage, the length of time and frequency the web user spent on a product page 426 or a category page that the product belongs to, and similarity of metadata of a referral page to the product page 426.

The referral webpage may be an internal webpage that leads the web user to a webpage of the target website 420 that is related to the target product. The referral webpage may also be an external webpage 410 that leads the web user to the target website 420. For example, if prior to visiting a webpage of the target website 420, the web user was browsing the external website 410 and was directed to the product page 426 of the target website 420 by clicking through a link provided by the external website 410, i.e., the external website 410 “refers” the web user to the target website 420, the index preprocessing unit 452 may be able to retrieve the online activities that the web user conducted in the referral website 410. The referral website 410 may be a search site 412, such as Yahoo!™ search webpage, an external website 414 providing information on related products, and/or a website for social network 416 (e.g. Facebook™), wherein members disclose and/or discuss their interest in the related products.

If the web user is directed to the target website 420 from an external website, such as the referral website 410, the index preprocessing unit 452 may be able to receive and extract search terms of the web user searched in the referral website 410 and/or metadata of the referral website 410 and process the received data with a database saved in the wrapper index 454.

For recent online activities of the user on the target website 420, the target website 420 may be able to process and send the required data to the index preprocessing unit 462. For example, if the required data is a value of a factor, the target website 420 may be able to calculate the value of the factor based on its own record of the online activities of web user. Then, the target website 420 may send the calculated value of the factor to the index preprocessing unit 452 as query parameters. The factor may reflect a length of time that the web user spent on a product page 426 or a category page 426 that the product belong to. The factor may also reflect a frequency during period of time with which the web user visited a product page 426 or a category page that the product belongs to. The target website 420 may send the calculated value of the factor to the index preprocessing unit 452 through web session API (application program provided interface), such as PHP session or cookies.

Alternatively, the target website 420 may embed an application program interface (“API”) of the online e-coupon distribution system 450, and may delegate the calculation to the application program. The application program may be a Web Service API for AJAX (Asynchronous JavaScript and XML) call and/or JavaScript code. The target website 420 may embed the API into specific webpages only, such as product pages 426, or may embed the API in all webpages it may deliver to the client device 470. The API may execute the delegated calculation and send the requested data to the index preprocessing unit 452.

In addition to the index preprocessing unit 452, the information of the historical and instant purchase intention of the web user may also be sent to the target server 456 for processing.

The index preprocessing unit 452 may collect and/or receive the recent and historical online activities of the web user periodically under defined time intervals or in real time. For example, the index preprocessing unit 452 may collect and/or receive the historical online activities of the web user from the backdoor server 430 every hour or every day. The index preprocessing unit 452 may collect and/or receive the recent online activities of the web user from the Grid 440 every second, hour, every day.

After receiving and/or collecting data of the recent and historical online activities of the web user, the index preprocessing unit 452 may communicate with a wrapper index 454 and send the data to the wrapper index 454 in structured data format. For example, the structured data format may be simple structured data format (SSDF), tecplot structured data format, JSON (JavaScript Object Notation) format, or any other structured formats available at the time of the filing of this application or in the future.

The index preprocessing unit 452 may also serve as an indexer to process and convert the data into an index and to send the index to the wrapper index 454. For example, the index preprocessing unit 452 may be configured to generate an index of content, such as for one or more databases. The index content may include associated contextual content and may be searched to locate content, including contextual content. The index may include index entries, wherein the index entry may be assigned a value referred to as a weight. The index entry may include a portion of the database. In some embodiments, the index preprocessing unit 452 may use an inverted index that stores a mapping from content to its locations in a database file, or in a document or a set of documents. The record level inverted index may contain a list of references to documents for each word. A word level inverted index additionally may contain the positions of each word within a document. A weight for the index entry may be assigned. For example, a weight, in one example embodiment, may be assigned substantially in accordance with a difference between the number of records indexed without the index entry and the number of records indexed with the index entry.

Alternatively, the wrapper index 454 may receive raw data of the recent and historical online activities of the web user and process the data into the structured data format or index.

The wrapper index 454 may communicate with the targeting server 456 for transmitting required data of the recent and historical online activities of the web user to the targeting server 456. The targeting server 456 may include a caching mechanism (e.g., STcache or memcache) to query the data saved in the wrapper index 454. The data also may be sent to a search engine (e.g. Vespa) (not shown), which may provide high performance query interface to the targeting server 456.

The targeting server 456 may communicate with an e-coupon database 460, from which the targeting server 456 may select e-coupons for various products that the target website 420 sells. Then the targeting server 456 may send a selected e-coupon to a webpage (e.g., the product page 426) of the target website 420 that is shown on the client device 470.

When the web user is visiting a webpage of the target website 422, the target server 456 may receive the historical and recent online activities information of the web user from the wrapper index 454 or the search engine. The targeting server 456 then may convert the recent and historical online activities information into purchase intention information associated with a target product. Alternatively, the recent and historical purchase intention information also may be converted and saved in the wrapper index 454 prior to the web user browsing the target website 420.

With the purchase intention (PI) information, the targeting server 456 may determine a present intention of the web user to purchase a target product. If the purchase intention of the web user to the target product is greater than a threshold, the targeting server 456 may select an e-coupon of the target product from the e-coupon database 460 and send the e-coupon to the webpage that the user is browsing. The e-coupon may be a pope up window, a banner, or a link appears on the webpage.

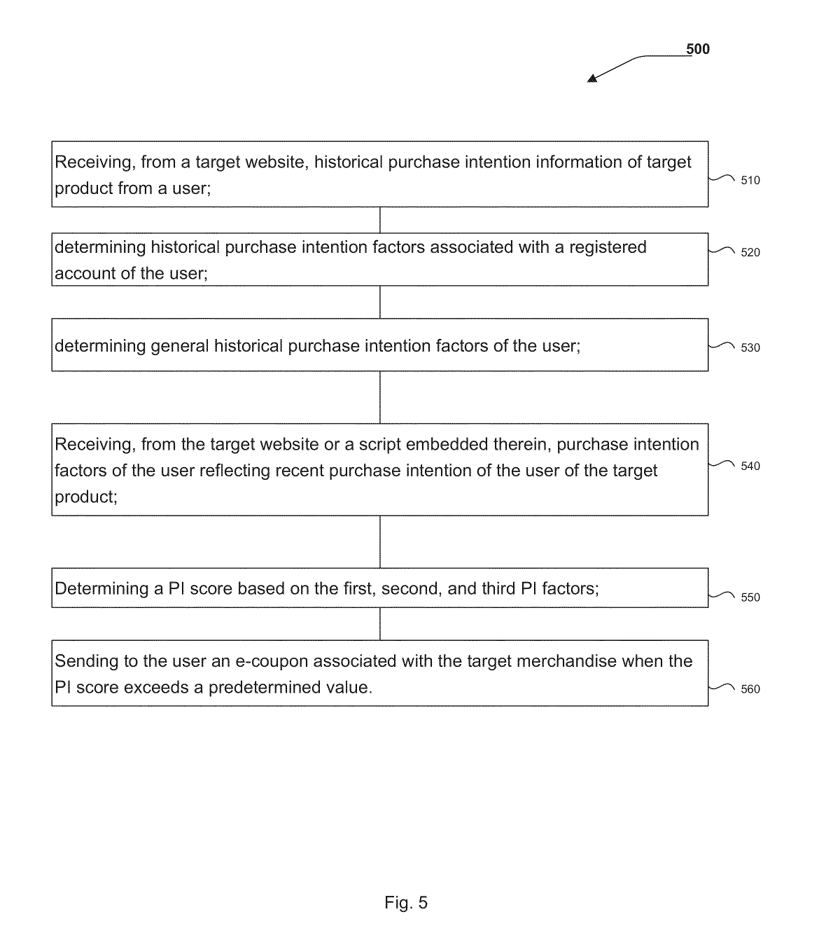

FIG. 5 is a flow chart illustrating a method for instantly distributing an e-coupon to a web user, according to an example embodiment of the present application. The method may require a server having a non-transitory computer-readable storage medium storing a set of instructions for online e-coupon distribution. The set of instructions may include a set of logic instructions and/or computer command for performing the online e-coupon distribution. For example, each step in FIG. 5 may be one or a set of logic instructions and/or computer commands for performing the online e-coupon distribution. The server may also have a processor in communication with the non-transitory computer-readable storage medium that is configured to execute the set of instructions stored in the computer-readable storage medium. In an example embodiment, the server may be the server 300 in FIG. 3. The server may also be the targeting server 456 in FIG. 4.

The method may be implemented by any other online sales promotion system available at the time of filing of this application or in the future, but for illustration purpose, the method is applied to the online e-coupon distribution system 450 shown in FIG. 4.

In step 510, the processor of the targeting server 456 may receive the historical purchase intention information associated with a web user and the target product.

In step 520, the processor of the targeting server 456 may determine a plurality of factors. These factors may associate with a registered account of the user and reflect historical purchase intention of the web user.

For example, the processor may determine a factor F1 that is associated with purchase record of the web user in the shopping cart 426 of the target website 420 within a defined period of time (e.g. 2 weeks, 4 weeks, or 14 weeks). Factor F1 may reflect whether the web user previously purchased the target product, or whether the web user previously purchased a product in a same category as the target product. Factor F1 may have a value between 0 and 1. For example: F1=1 if the web user purchased a target product within 4 weeks; F1=0.5 if the web user purchase a product in the same category as the target product within 4 weeks; and F1=0 if the web user purchased neither a target product nor a product in the same category as the target product within 4 weeks.

The processor may also determine a factor F2 that is associated with the watch list 424 the web user in the target website 420. Factor F2 may reflect whether the watch list 424 includes the target product or a product in a same category of the target product within a defined period of time (e.g. 2 weeks, 4 weeks, or 14 weeks). Factor F2 may have a value between 0 and 1. For example, F2=1 if the web user includes the target product in the watch list within 4 weeks; F2=0.5 if the watch list includes a product in the same category as the target product within 4 weeks; and F2=0 if the watch list includes neither the target product nor a product in the same category as the target product within 4 weeks.

Both F1 and F2 are factors reflecting historical purchase intention of the web user that are associated with a registered account of the web user, and are thus account specific.

In step 530, the processor of the targeting server 456 may determine factors that reflecting general historical purchase intention of the user, i.e., historical purchase intention not associated with the registered account of the user.

For example, the processor may determine a factor F3 that is associated with the product Q$A webpage 422 of the target product. Factor F3 may reflect whether the web user has viewed, asked questions, answered questions, and/or commented on the product Q&A webpage 422 within a defined period of time (e.g. 2 weeks, 4 weeks, or 14 weeks). Factor F3 may have a value between 0 and 1. For example, within 4 weeks, if the web user has asked a question in the product Q&A page 422 of the target product, F3=1; if the web user has asked a question in a product Q&A webpage 422 of the same category as the target product, F3=0.75; if the web user has browsed the product Q&A page 422 of the target product, F3=0.5; if web user has browsed a product Q&A page 422 of the same category as the target product, F3=0.25; and if the web user has neither browsed nor participated any discussion related to the target product or a category of the target product in a product Q&A page 422, F3=0.

The processor of the targeting server 456 may also determine a factor F4 reflecting whether the user has viewed within a defined period of time (e.g. 2 weeks, 4 weeks, or 14 weeks) the product page 426. The factor F4 may have a value between 0 and 1. For example, within 4 weeks, if the web user has viewed the product page 426 of the target product for n times (n≧1),
F4=1, if n>3,
F4=0.75, if 2≦n≦3, and
F4=0.60, if n=1;
   if the web user has viewed a product page 426 of the same category as the target product for n times (n≧1),
F4=0.50, if n>3,
F4=0.35, if 2≦n≦3, and
F4=0.25, if n=1;
   and if the web user has never viewed a product page 426 of the target product and/or a product of the same category of the target product, F4=0.

The processor of the targeting server 456 may also determine a factor F5 reflecting, within a defined period of time (e.g. 2 weeks, 4 weeks, or 14 weeks), a number of webpages that the user has navigated through when searching keywords that are related to the target product. Factor F5 may have a value between 0 and 1. For example, within 4 weeks, if the web user has searched the target product or a related keyword of the target product and click though n result links,
F5=1, if n>3,
F5=0.75, if 2≦n≦3,
F5=0.5, if n=1, and
F5=0, if otherwise.

In addition, the processor of the targeting server 456 may also determine a factor F9 reflecting whether the web user has demonstrate special interest to the target product on external website other than referral website within a defined period of time (e.g. 2 weeks, 4 weeks, or 14 weeks). For example, the web user may be a registered member of an external website (e.g. a social network website) and discussed with his/her friend on the website issues related to the target product. Factor F9 may have a value between 0 and 1. For example, within 4 weeks, if the web user has discussed the target product with others in the external website, F9=1; if the web user has discussed issues related to a product of the same category as the target product, F9=0.5; and If the web user has never discuss any issues related to the target product, F9=0. Factor F9 may be an optional factor in determining an historical purchase intention of the web user.

F3, F4, F5, and F9 are factors reflecting general purchase intention of the web user, i.e., they are not associated with a specified registered account of the web user. Further, F1, F2, F3, F4, F5, and F9 may be factors reflecting purchase intention of the web user during a relatively long period of time (e.g., 2 weeks, 4 weeks, 14 weeks), thus are historical purchase intention factors.

In step 540, the processor of the targeting server 456 may receive factors reflecting instant purchase intention of the user determined by the target website 420 or by the API embedded therein.

For example, the processor of the targeting server 456 may receive a factor F6 reflecting relativity between the target product and one or more terms that the user has submitted to a search engine within a defined period of time (e.g. 1 hour, 1 day, or 7 days). Factor F6 may have a value between 0 and 1. The search engine may be a referral website. For example, the targeting server 456 may be able to receive the search terms that the web user searched within 1 hour from referral websites or links (e.g., from the referral website 410) and compare the search terms with related keywords from a keyword database (not shown) saved in the wrapper index 454. If a search term matches the target product name, F6=1; if the search term matches one of the related keywords of the target product, F6=0.90; if the search term matches the category of which the target product belongs to, F6=0.80; if the search term matches one of the related keywords of the category of the target product, F6=0.70; and for any other situation, F6=0.

The processor of the targeting server 456 may receive a factor F7 that reflects, during a defined period of time (e.g., 1 hour, 1 day, or 7 days), a length of time that the web user spent navigating webpages associated with the target product and a frequency with which the web user searched for webpages or viewed webpages associated with the target product. For example, the webpages may be the product page 426 and the product Q&A page 422 of the target product and/or a category of the target product. The factor F7 may have a value between 0 and 1. For example, within 5 hours, if the web user switched n times (n>1) between an unrelated webpage and an related webpage of the target product, such as the product page 426 and product Q&A page 422, and the total time the web user spent viewing these webpages was m minutes (m>10),
F7=1, if n>3, m>10,
F7=0.9, if 2≦n≦3, m>10, and
F7=0.8, if n=1, m>10;
   if the web user switched n times (n>1) between a product page 426 and product Q&A page 422 of a product in a same category as the target product, and the total time the web user spent viewing these webpages was m minutes (m>10),
F7=0.7, if n>3, m>10
F7=0.6, if 2≦n≦3, m>10, and
F7=0.5, if n=1, m>10.
   For any other situations, F7=0.

The processor of the targeting server 456 may receive a factor F8 reflecting similarity between metadata of the external referral webpage 412, 414, 416 and metadata of the webpages of the target website 420 that the web user viewed within a defined period of time (e.g., 1 hour, 1 day, or 7 days). The factor F8 may have a value between 0 and 1. For example, the web user browsed the product page 426 within 1 hour. Accordingly, F8=1 if the metadata of the referral webpage 412, 414, 416 is the same as the metadata of the target product page 426, i.e., the referral webpage 412, 414, 416 is an external webpage of the target product the target product; F8=0.8 if the metadata of the referral page matches a related keyword of the target product in the keyword database saved in the wrapper index 454; F8=0.6 if the metadata of the referral webpage 412, 414, 416 is the same as the category that the target product belongs to; F8=0.5 if the metadata of the referral page matches a related keyword of the category of the target product in the keyword database saved in the wrapper index 454; and F8=0 for other situations.

F6, F7, and F8 are factors reflecting general purchase intention of the web user, i.e., they are not associated with a specified registered account of the user. Further, F6, F7, and F8 are factors reflecting purchase intention of the web user in a relatively recent period of time (e.g., 1 hour, 1 day, or 7 days) compared to factors F1-F5, thus are instant purchase intention factors strongly indicating the present purchase intention of the web user.

In step 550, the processor of the targeting server 456 may determine, based on the purchase intention factors (e.g., F1-F8), a purchase intention score (PI score) that reflects a present purchase intention of the user associated with the target product. The PI score may be expressed as:

PI score=(Σᵢ₌₁^{m}aᵢ·Fᵢ)/m

wherein Fi is a purchase intention factor and ai is a weight representing the importance of the purchase intention factor Fi in determining the PI score.

If the web user is a registered user and logged in his/her account registered in the target website 422, the targeting server 456 may recognize the identity of the user through his/her account. Thus may be able to receive the account specific information of the user. Accordingly, if every purchase intention factor is treated equally important, i.e., ai=1, the PI score of the web user may be expressed as:

PI score=(F1+F2+F3+F4+F5+F6+F7+F8+F9)/9

When the optional purchase intention factor F9 is not taken into account, the PI score of the web user may be expressed as:

PI score=(F1+F2+F3+F4+F5+F6+F7+F8)/8

If the web user does not log in his/her account when browsing the target website 420, the targeting server 456 may not be able to receive the account specific information of the web user but may still recognize the client device 470 of the web user. Thus the targeting server 456 may be able to determine the general historical purchase factors and instant purchase intention factors of the web user. Accordingly, if every purchase intention factor is treated equally important, i.e., ai=1, the PI score of the user maybe expressed as:

PI score=(F3+F4+F5+F6+F7+F8+F9)/7

When the optional purchase intention factor F9 is not taken into account, the PI score of the web user may be expressed as:

PI score=(F3+F4+F5+F6+F7+F8)/6

Because each purchase intention factor F1-F9 is scaled to a value between 0 and 1, the PI score may be of a value between 0 and 1 as well.

In step 560, the processor of the targeting server 456 may compare the value of the PI score with a tipping point (i.e., a threshold value). If the PI score is greater than the tipping point, the web user may be deemed to have a strong present purchase intention to the target product. The targeting server 456 may communicate with the e-coupon database 460, select one or more e-coupons associated with the target product, and send the selected e-coupons to the webpage that the web user is browsing through the client device 470. The e-coupon may be a pope up window, a banner, a link appears on the webpage, a message sent to the registered account of the web user, and/or any other suitable forms. The value of the tipping point may be 0.5, or may be determined by artificial intelligence (AI) or fuzzy data models that implement machine learning programs.

As described above, systems and computer-implemented methods may provide present purchase intention computation for an online shop owner, platform provider, manufactures, and/or merchants in instant online e-coupon distribution. In some implementations, the described systems and methods may compute a PI score of a web user with respect to a target product, based on general online activities of the web user associated with a target product. In other implementations, the described systems and methods may compute the PI score based on account specific online activities information as well as the general online activities of the web user associated with a target product.

However, it is intended that the foregoing detailed description be regarded as illustrative rather than limiting, and that it be understood that it is the following claims, including all equivalents, that are intended to define the spirit and scope of this invention.

For example, while the above-described systems and methods have been described with respect to online e-coupon distribution, it will be appreciated that the same systems and methods may be implemented to other types of online sales promotions, such as rebates, samples, contests, loyalty awards.

Further, while the above-described systems and methods have been described with respect to distribution of online e-coupon, it will be appreciated that the same systems and methods may be implemented to online advertisement display.

In addition, while example embodiments have been particularly shown and described with reference to FIGS. 1-5, it will be understood by one of ordinary skill in the art that various changes in form and details may be made therein without departing from the spirit and scope of example embodiments, as defined by the following claims. The example embodiments, therefore, are provided merely to be illustrative and subject matter that is covered or claimed is intended to be construed as not being limited to any example embodiments set forth herein. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” or “in one example embodiment” as used herein does not necessarily refer to the same embodiment and the phrase “in another embodiment” or “in another example embodiment” as used herein does not necessarily refer to a different embodiment. It is intended, for example, that claimed subject matter include combinations of example embodiments in whole or in part.

The terminology used in the specification is for the purpose of describing particular embodiments only and is not intended to be limiting of example embodiments of the invention. In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Likewise, it will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof, and in the following description, the same reference numerals denote the same elements.

We claim:

1. A server comprising:
a non-transitory computer-readable storage medium comprising a set of instructions for online sales promotion;
a processor in communication with the non-transitory computer-readable storage medium that is configured to execute the set of instructions stored in the computer-readable storage medium and is configured to:
receive purchase intention (PI) information associated with a user and a target product, the PI information comprising a plurality of PI factors, wherein the plurality of PI factors comprise:
a first factor reflecting historical purchase intention of the user and associated with a registered account of the user;
a second factor reflecting historical purchase intention of the user not associated with the registered account of the user; and
a third factor reflecting instant purchase intention of the user;
determine, based on the plurality of PI factors, a PI score that reflects a present purchase intention of the user associated with the target product; and
provide an online sales promotion associated with the target product to a target webpage rendered to the user when the PI score exceeds a predetermined value.

2. The server according to claim 1, wherein the first factor is associated with at least one of:
whether an account associated with the user shows that the user previously purchased the target product or previously purchased a product in a same category as the target product; and
whether a watch list of the user comprises the target product or comprises a product in a same category of the target product.

3. The server according to claim 1, wherein the second factor is associated with at least one of:
whether the user has viewed within a defined period of time a product question and answer webpage that is associated with the target product;
whether the user has viewed within a defined period of time a webpage of the target product;
a number of webpages that the user has navigated through when searching keywords that are related to the target product; and
personal interest information associated with the target product reflected from general internet activities of the user.

4. The server according to claim 1, wherein the third factor is associated with at least one of:
relativity between the target product and one or more terms that the user has submitted to a search engine within a defined period of time;
a length of time that the user spent navigating webpages associated with the target product, and during a defined period of time, a frequency with which the user searched for webpages or viewed webpages associated with the target product; and
similarity between metadata of a referral webpage that directs the user to a current webpage and metadata of the current webpage that the user views within a defined period of time.

5. The server according to claim 1, wherein the processor is further configured to:
periodically receive the third factor of the user associated with the target product from a server of the target website or a script embedded in the target website,
wherein the third factor is calculated based on the instant purchase intention of the user.

6. The server according to claim 1, wherein the processor is further configured to:
integrate an index preprocessing component into the target website;
periodically receive from the target website through the index preprocessing component, when the user logs into the target website, the historical purchase intention associated with the registered account; and
calculate the first factor based on the historical purchase intention associated with the registered account.

7. The server according to claim 1, wherein the processor is further configured to:
integrate an index preprocessing component into the target website;
periodically receive from the target website through the index preprocessing component, historical purchase intention not associated with the registered account; and
calculate the second factor based on the historical purchase intention not associated with the registered account.

8. The server according to claim 1, wherein the online sales promotion is an e-coupon that expires within 2 hours.

9. A computer-implemented method for online sales promotion, the method comprising:
receiving, by a processor, purchase intention (PI) information associated with a user and a target product, the PI information comprising a plurality of PI factors, wherein the plurality of PI factors comprise:
a first factor reflecting historical purchase intention of the user and associated with a registered account of the user;
a second factor reflecting historical purchase intention of the user not associated with the registered account of the user; and
a third factor reflecting instant purchase intention of the user;
determining, by a processor based on the plurality of PI factors, a PI score that reflects a present purchase intention of the user associated with the target product; and
providing, by a processor, an online sales promotion associated with the target product to a target webpage rendered to the user when the PI score exceeds a predetermined value.

10. The computer-implemented method according to claim 9, wherein the first factor is associated with at least one of:
whether an account associated with the user shows that the user previously purchased the target product or previously purchased a product in a same category as the target product; and
whether a watch list of the user comprises the target product or comprises a product in a same category of the target product.

11. The computer-implemented method according to claim 9, wherein the second factor is associated with at least one of:
whether the user has viewed within a defined period of time a product question and answer webpage that is associated with the target product;
whether the user has viewed within a defined period of time a webpage of the target product;
a number of webpages that the user has navigated through when searching keywords that are related to the target product; and
personal interest information associated with the target product reflected from general internet activities of the user.

12. The computer-implemented method according to claim 9, wherein the third factor is associated with at least one of:
relativity between the target product and one or more terms that the user has submitted to a search engine within a defined period of time;
a length of time that the user spent navigating webpages associated with the target product, and during a defined period of time, a frequency with which the user searched for webpages or viewed webpages associated with the target product; and
similarity between metadata of a referral webpage that directs the user to a current webpage and metadata of the current webpage that the user views within a defined period of time.

13. The computer-implemented method according to claim 9, further comprising:
periodically receiving, by a processor, the third factor of the user associated with the target product from a server of the target website or a script embedded in the target website,
wherein the third factor is calculated based on the instant purchase intention of the user.

14. The computer-implemented method according to claim 9, further comprising:
Integrating, by a processor, an index preprocessing component into the target website;
periodically receiving, by a processor, from the target website through the index preprocessing component, when the user logs into the target website, the historical purchase intention associated with the registered account; and
calculating, by a processor, the first factor based on the historical purchase intention associated with the registered account.

15. The computer-implemented method according to claim 9, further comprising:
integrating, by a processor, an index preprocessing component into the target website;
periodically receiving, by a processor, from the target website through the index preprocessing component, historical purchase intention not associated with the registered account; and
calculating, by a processor, the second factor based on the historical purchase intention not associated with the registered account.

16. The computer-implemented method according to claim 9, wherein the online sales promotion is an e-coupon that expires within 2 hours.

17. A non-transitory computer-readable storage medium comprising a set of instructions for online sales promotion, the set of instructions to direct a processor to perform acts of:
receiving purchase intention (PI) information associated with a user and a target product, the PI information comprising a plurality of PI factors, wherein the plurality of PI factors comprise:
a first factor reflecting historical purchase intention of the user and associated with a registered account of the user;
a second factor reflecting historical purchase intention of the user not associated with the registered account of the user; and
a third factor reflecting instant purchase intention of the user;
determining, based on the plurality of PI factors, a PI score that reflects a present purchase intention of the user associated with the target product; and
providing an online sales promotion associated with the target product to a target webpage rendered to the user when the PI score exceeds a predetermined value.

18. The non-transitory computer-readable storage medium according to claim 17, wherein the first factor is associated with at least one of:
whether an account associated with the user shows that the user previously purchased the target product or previously purchased a product in a same category as the target product;
whether a watch list of the user comprises the target product or comprises a product in a same category of the target product;
wherein the second factor is associated with at least one of:
whether the user has viewed within a defined period of time a product question and answer webpage that is associated with the target product;
whether the user has viewed within a defined period of time a webpage of the target product;
a number of webpages that the user has navigated through when searching keywords that are related to the target product;
personal interest information associated with the target product reflected from general internet activities of the user; and
wherein the third factor is associated with at least one of:
relativity between the target product and one or more terms that the user has submitted to a search engine within a defined period of time;
a length of time that the user spent navigating webpages associated with the target product, and during a defined period of time, a frequency with which the user searched for webpages or viewed webpages associated with the target product; and
similarity between metadata of a referral webpage that directs the user to a current webpage and metadata of the current webpage that the user views within a defined period of time.

19. The non-transitory computer-readable storage medium according to claim 17, wherein the set of instructions to direct the processor to further perform acts of:
periodically receiving the third factor of the user associated with the target product from a server of the target website, or a script embedded in the target website,
wherein the third factor of the user is calculated based on the instant purchase intention of the user.

20. The computer-implemented method according to claim 17, the set of instructions to direct the processor to further perform acts of:
integrating an index preprocessing component into the target website;
periodically receiving from the target website through the index preprocessing:
component historical purchase intention not associated with the registered account; and
the historical purchase intention associated with the registered account when the user logs into the target website;
calculating the first factor based on the historical purchase intention associated with the registered account; and
calculating the second factor based on the historical purchase intention not associated with the registered account.
